(19) United States
(12) Patent Application Publication
(10) Pub. No.: US 2024/0393197 A1
(43) Pub. Date: Nov. 28, 2024

(54) COLD-CAST ANCHOR STAY CABLE CONTAINING FIBER GRATING STRAIN AND INSTALLATION METHOD THEREOF

(71) Applicant: Guangxi University, Nanning (CN)

(72) Inventors: Nianchun DENG, Nanning (CN); Guohua LV, Nanning (CN); Xiao GUO, Nanning (CN); Zhaotao CHEN, Nanning (CN)

(21) Appl. No.: 18/336,068

(22) Filed: Jun. 16, 2023

(30) Foreign Application Priority Data
May 25, 2023 (CN) 2023106026362

(51) Int. Cl. G01L 1/24; E01D 19/14; E01D 19/16

(52) U.S. Cl. CPC G01L 1/246; E01D 19/14; E01D 19/16

(57) ABSTRACT

A cold-cast anchor stay cable containing fiber grating strain and an installation method are provided. The stay cable includes an anchor head structure, where one end of the anchor head structure is fixedly connected with an extension structure, one end of the extension structure away from the anchor head structure is fixedly connected with a cable body, and a plurality of steel strands are fixedly connected inside the anchor head structure, and the steel strands sequentially pass through the anchor head structure and the extension structure and are fixedly connected with one end of the cable body. A spot welding high-temperature grating sensor is fixedly connected to a side surface of a part of one of the steel strands located in the extension structure.

### CROSS-REFERENCE TO RELATED APPLICATIONS

This disclosure claims priority to Chinese Patent Application No. 202310602636.2,filed on May 25, 2023, the contents of which are hereby incorporated by reference.

### TECHNICAL FIELD

The disclosure belongs to the technical field of bridge stay cable manufacturing and monitoring, and in particular to a cold-cast anchor stay cable containing fiber grating strain and an installation method thereof.

### BACKGROUND

Steel strand stay cables are widely used in bridge engineering. Especially in arch bridges, cable-stayed bridges and suspension bridges, the steel strand cables bear important stress structures. Real-time monitoring of cable forces of the steel strand stay cables plays an important role in expanding spans of bridges.

Existing cable force detection methods mainly include: a pressure gauge measurement method, a pressure sensor measurement method, a frequency method and a magneto-elastic method. The pressure gauge measurement method and the pressure sensor measurement method are generally used to measure cable forces when stay cables are tensioned. The magneto-elastic method has disadvantages of instability and easy interference from external factors, so the frequency method is almost the only choice for long-term monitoring of the stay cables. Existing cable force detection sensors have characteristics of poor stability, low survival rate and poor durability during installation and operation, so long-term monitoring requirements of the cable force are not met. Therefore, a steel strand, a cold-cast anchor stay cable containing fiber grating strain and an installation method thereof are urgently needed to solve shortcomings in the prior art.

### SUMMARY

An objective of the disclosure is to provide a cold-cast anchor stay cable containing fiber grating strain and an installation method thereof, so as to solve the above problems and achieve objectives of improving stability of a device and increasing measurement accuracy.

In order to achieve the above objectives, the disclosure provides a following scheme.

A cold-cast anchor stay cable containing fiber grating strain, including an anchor head structure, where one end of the anchor head structure is fixedly connected with an extension structure, and one end of the extension structure away from the anchor head structure is fixedly connected with a cable body; a plurality of steel strands are fixedly connected inside the anchor head structure, and the steel strands sequentially pass through the anchor head structure and the extension structure and are fixedly connected with one end of the cable body; a spot welding high-temperature grating sensor is fixedly connected to a side surface of a part of one of the steel strands located in the extension structure.

Optionally, the anchor head structure includes an anchor head, where an inner side of the anchor head is provided with a perforation; one end of the perforation is fixedly connected with a cover plate, and an other end of the perforation is fixedly connected with a cable band, and epoxy mortar is poured between the cover plate and the cable band; one end of the anchor head close to the cable band is provided with an anchor head clamping groove, and the extension structure is fixedly connected with the anchor head clamping groove.

Optionally, the cover plate is fixedly connected with a plurality of extrusion heads; the extrusion heads are arranged along an axial direction of the cover plate, and the plurality of extrusion heads are respectively fixedly connected with the steel strands.

Optionally, a cross section of the perforation is stepped.

Optionally, the extension structure includes an extension cylinder; one end of the extension cylinder is fixedly connected with the anchor head clamping groove, and an other end of the extension cylinder is fixedly connected with the cable body, and a sealant is poured into the extension cylinder.

Optionally, one end of the spot welding high-temperature grating sensor is electrically connected with an optical fiber, and an end of the optical fiber away from the spot welding high-temperature grating sensor extends out of the extension cylinder.

An installation method of the cold-cast anchor stay cable containing the fiber grating strain, including:

S1, applying friction to a welding point surface of the one of the steel strands and cleaning the welding point surface;

S2, welding the spot welding high-temperature grating sensor;

S3, connecting the optical fiber with an external cable force testing device;

S4, painting for protection on the spot welding high-temperature grating sensor; S5, pouring the sealant from the cable band to the extension cylinder;

S6, pouring the epoxy mortar into the anchor head and putting the epoxy mortar into a hot furnace for heating, heat preservation and curing after the sealant is cooled and solidified; and

S7, testing an installation result and accuracy of the spot welding high-temperature grating sensor.

Optionally, the method includes: in the step S6, a temperature of the hot furnace is controlled at 180 degrees Celsius, and a time of the heating and the preservation is controlled at 24 hours.

Compared with the prior art, the disclosure has following advantages and technical effects.

The anchor head structure is arranged to fix the extension structure and the cable body. When the cable body is stretched, the steel strands inside the extension structure change in tension, thereby changing reading of the spot welding high-temperature grating sensor, so that external personnel may observe a stress condition of the cable body. A device according to the disclosure is a whole, and the spot welding high-temperature grating sensor is buried inside the extension structure, so a service life may be effectively prolonged, aging interference is reduced, measurement accuracy is improved and external interference is reduced, thereby achieving long-term and real-time stable detection of the stress condition of the cable body. Using these structures, the cold-cast anchor stay cable containing the fiber grating strain and the installation method thereof are realized, which may solve a creep phenomenon when installing the sensor, avoid a damage of the sensor, improve accuracy of cable force detection of the stay cable, and feedback the cable force in real time.

Moreover, raw materials used in the disclosure are abundant, low in price, suitable for industrial production and have good economic benefits.

### BRIEF DESCRIPTION OF THE DRAWINGS

In order to explain embodiments of the disclosure or technical schemes in the prior art more clearly, drawings needed in the embodiments may be briefly introduced below. Obviously, the drawings in a following description are only some embodiments of the disclosure. For ordinary people in the field, other drawings may be obtained according to these drawings without paying a creative labor.

FIG. 1 is a sectional view of the disclosure.

FIG. 2 is a schematic diagram of a welding point of a steel strand.

FIG. 3 is a schematic structural diagram of a spot welding high-temperature grating sensor.

FIG. 4 is an exploded view of a spot welding high-temperature grating sensor.

FIG. 5 is a flowchart of an installation method of a cold-cast anchor stay cable containing fiber grating strain according to the disclosure.

### DETAILED DESCRIPTION OF THE EMBODIMENTS

In the following, technical schemes in embodiments of the disclosure may be clearly and completely described with reference to attached drawings. Obviously, the described embodiments are only a part of the embodiments of the disclosure, but not all embodiments. Based on the embodiments in the disclosure, all other embodiments obtained by ordinary technicians in the field without a creative labor belong to a scope of protection of the disclosure.

In order to make above objects, features and advantages of the disclosure more obvious and easier to understand, the disclosure may be further described in detail with the attached drawings and specific embodiments.

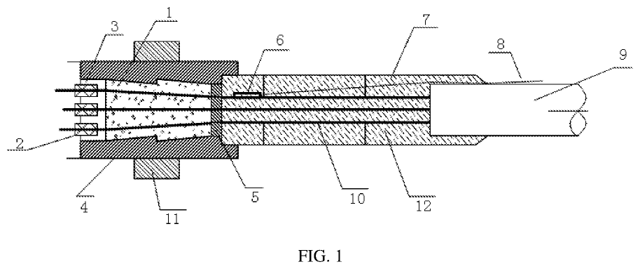

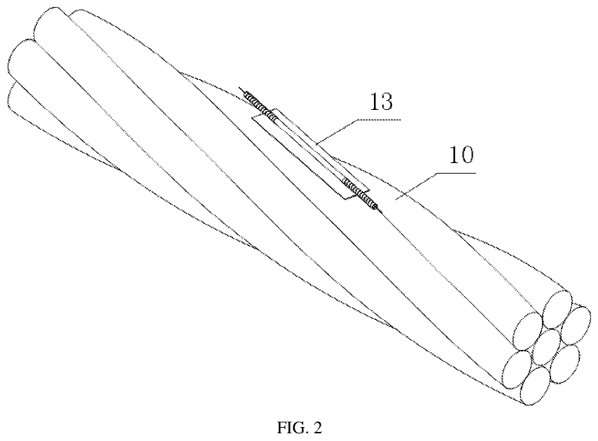

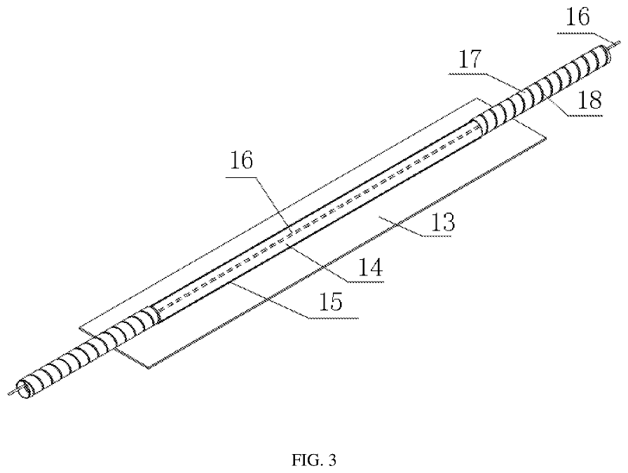

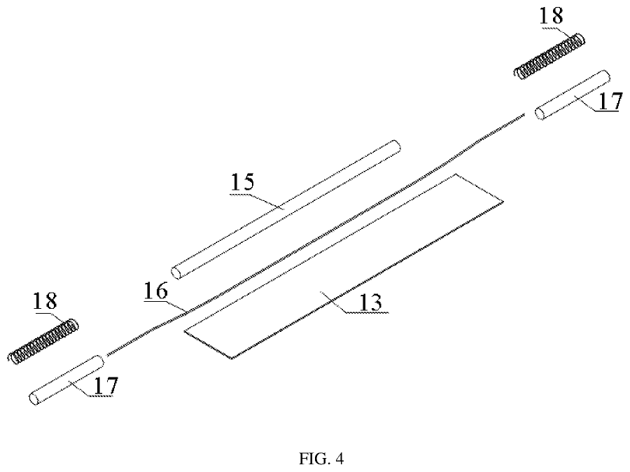

With reference to FIGS. 1-4, the disclosure provides a cold-cast anchor stay cable containing fiber grating strain, including an anchor head structure, where one end of the anchor head structure is fixedly connected with an extension structure, and one end of the extension structure away from the anchor head structure is fixedly connected with a cable body 9. A plurality of steel strands 10 are fixedly connected inside the anchor head structure, and the steel strands 10 sequentially pass through the anchor head structure and the extension structure and are fixedly connected with one end of the cable body 9. A spot welding high-temperature grating sensor 6 is fixedly connected to a side surface of a part of one of the steel strands 10 located in the extension structure.

The anchor head structure is arranged to fix the extension structure and the cable body 9. When the cable body 9 is stretched, the steel strands 10 inside the extension structure change in tension, thereby changing reading of the spot welding high-temperature grating sensor 6, so that external personnel may observe a stress condition of the cable body 9. A device according to the disclosure is a whole, and the spot welding high-temperature grating sensor 6 is buried inside the extension structure, so a service life may be effectively prolonged, aging interference is reduced, measurement accuracy is improved and external interference is reduced, thereby achieving long-term and real-time stable detection of the stress condition of the cable body 9.

In a further optimization scheme, the anchor head structure includes an anchor head 4, where an inner side of the anchor head 4 is provided with a perforation. One end of the perforation is fixedly connected with a cover plate 3, and an other end of the perforation is fixedly connected with a cable band 5, and epoxy mortar 1 is poured between the cover plate 3 and the cable band 5. One end of the anchor head 4 close to the cable band 5 is provided with an anchor head clamping groove, and the extension structure is fixedly connected with the anchor head clamping groove. The cover plate 3 and the cable band 5 cooperate with each other to seal the anchor head 4, so that the epoxy mortar 1 inside the anchor head 4 remains stable during heating and curing, and a reinforcement effect is improved.

In a further optimization scheme, the cover plate 3 is fixedly connected with a plurality of extrusion heads 2. The extrusion heads 2 are arranged along an axial direction of the cover plate 3, and the plurality of extrusion heads 2 are respectively fixedly connected with the steel strands 10. An arrangement of the extrusion heads 2 improves a reinforcement effect of the steel strands 10.

In a further optimization scheme, a cross section of the perforation is stepped. A stepped structure improves a fixing effect of the cured epoxy mortar 1 and prevents the epoxy mortar 1 from loosening.

In a further optimization scheme, the extension structure includes an extension cylinder 7. One end of the extension cylinder 7 is fixedly connected with the anchor head clamping groove, and an other end of the extension cylinder 7 is fixedly connected with the cable body 9, and a sealant 12 is poured into the extension cylinder 7.

A periphery of the spot welding high-temperature grating sensor 6 is coated with a protective layer. The protective layer is a paint surface to protect the spot welding high-temperature grating sensor 6.

In a further optimization scheme, one end of the spot welding high-temperature grating sensor 6 is electrically connected with an optical fiber 8, and an end of the optical fiber 8 away from the spot welding high-temperature grating sensor 6 extends out of the extension structure, and a periphery of the optical fiber 8 is sheathed with a high-temperature protective sleeve. The high-temperature protective sleeve may protect the optical fiber 8 from being stable when the sealant 12 in the extension cylinder 7 is cured by heating.

By arranging the spot welding high-temperature grating sensor 6 om the periphery of one of the steel strands 10 and pouring the sealant 12 into the extension cylinder 7, it is ensured that the spot welding high-temperature grating sensor 6 is protected by the extension cylinder 7 when working, so that the external interference may be isolated and cable force data may be detected in real time. Moreover, a creep phenomenon existing in installation in the prior art is solved, precision and accuracy of the cable force are improved, a damage of the spot welding high-temperature grating sensor 6 is avoided, and intelligence of cable force detection of the stay cable is realized.

The spot welding high-temperature grating sensor 6 includes a stainless steel substrate 13. The stainless steel substrate 13 is arranged along a length direction of the one of the steel strands 10. The stainless steel substrate 13 is fixedly welded with an outer side wall of the one of the steel strands 10. A side of the stainless steel substrate 13 away from the one of the steel strands 10 is fixedly connected with a stainless steel tube 15 along the length direction, and both ends of the stainless steel tube 15 are fixedly connected with protective structures respectively. An inner side of the stainless steel tube 15 is fixedly penetrated with a series sensor group through a high temperature glue 14, and the series sensor group is arranged along a length direction of the stainless steel tube 15.

One end of the series sensor group is fixedly connected with the optical fiber 8, and one end of the optical fiber 8 away from the series sensor group is electrically connected with an external cable force testing device. The periphery of the optical fiber 8 is sheathed with the high-temperature protective sleeve, and the high-temperature protective sleeve is used to protect the optical fiber 8 from deformation during heating.

Each of the protective structures includes a steel wire armor 18, and the steel wire armor 18 is sleeved around the series sensor group, and a heat shrinkable tube 17 is fixedly sleeved outside the steel wire armor 18.

The series sensor group includes several strain fiber grating sensors 16, and the several strain fiber grating sensors 16 are connected in series in turn, and one of the strain fiber grating sensors 16 located at an end is electrically connected with the optical fiber 8.

A nut 11 is sleeved around the anchor head 4. An arrangement of the nut 11 may make the anchor head 4 more stable.

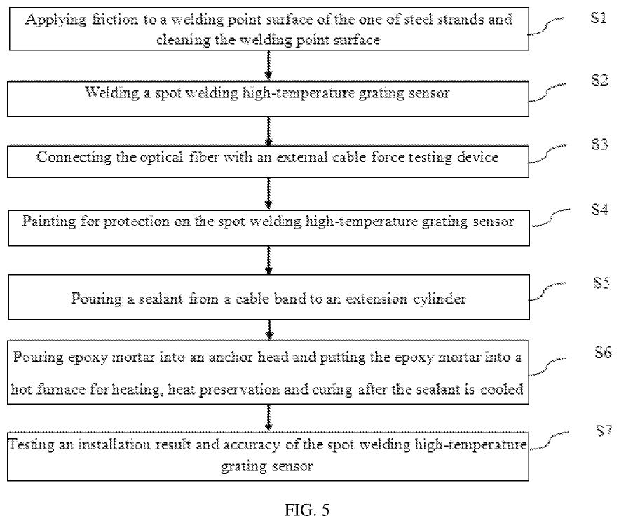

As shown in FIG. 5, an installation method of the cold-cast anchor stay cable containing the fiber grating strain, including following steps:

S1, polishing a welding point surface of the one of the steel strands 10, and cleaning and disinfecting with alcohol;

S2, welding the stainless steel substrate 13 to the welding point surface of the one of the steel strands 10;

S3, pulling the optical fiber 8 out of the extension cylinder 7 and connecting the optical fiber 8 with the external cable tension testing device;

S4, performing paint protection on the spot welding high-temperature grating sensor 6;

S5, sheathing the optical fiber 8 with the high-temperature protective sleeve, and pouring the sealant 12 from the cable band 5 to the extension cylinder 7;

S6, pouring the epoxy mortar 1 into the anchor head 4 from the cover plate 3 after the sealant 12 is cooled and solidified, and putting the anchor head 4 into a hot furnace for heating and heat preservation to solidify the epoxy mortar 1; and

S7, detecting compactness of the sealant 12 in the extension cylinder 7 by using an ultrasonic detector, and testing an installation result and accuracy of the spot welding high-temperature grating sensor 6 by reading the external cable force testing device.

In a further optimization scheme, in the step S6, a temperature of the hot furnace is controlled at 180 degrees Celsius, and a time of the heating and the preservation is controlled at 24 hours. Through this setting, heating, heat preservation and curing effect may be better.

In a description of the disclosure, it should be understood that terms “vertical”, “horizontal”, “up”, “down”, “front”, “back”, “left”, “right”, “vertical”, “horizontal”, “top”, “bottom”, “inside”, “outside”, and other indications of orientation or positional relationships are based on orientation or positional relationships shown in accompanying drawings, solely for a convenience of describing the disclosure, rather than indicating or implying that a device or a component referred to must have a specific orientation, be constructed and operated in a specific orientation, therefore it may not be understood as a limitation of the disclosure.

The above-mentioned embodiments only describe preferred modes of the disclosure, and do not limit a scope of the disclosure. Under a premise of not departing from a design spirit of the disclosure, various modifications and improvements made by ordinary technicians in the field to the technical scheme of the disclosure shall fall within a protection scope determined by claims of the disclosure.

What is claimed is:

1. A cold-cast anchor stay cable containing fiber grating strain, comprising an anchor head structure, wherein one end of the anchor head structure is fixedly connected with an extension structure, and one end of the extension structure away from the anchor head structure is fixedly connected with a cable body; a plurality of steel strands are fixedly connected inside the anchor head structure, and the steel strands sequentially pass through the anchor head structure and the extension structure and are fixedly connected with one end of the cable body; and a spot welding high-temperature grating sensor is fixedly connected to a side surface of a part of one of the steel strands located in the extension structure.

2. The cold-cast anchor stay cable containing the fiber grating strain according to claim 1, wherein the anchor head structure comprises an anchor head, wherein an inner side of the anchor head is provided with a perforation; one end of the perforation is fixedly connected with a cover plate, and an other end of the perforation is fixedly connected with a cable band, and epoxy mortar is poured between the cover plate and the cable band; one end of the anchor head close to the cable band is provided with an anchor head clamping groove, and the extension structure is fixedly connected with the anchor head clamping groove.

3. The cold-cast anchor stay cable containing the fiber grating strain according to claim 2, wherein the cover plate is fixedly connected with a plurality of extrusion heads; the extrusion heads are arranged along an axial direction of the cover plate, and the plurality of extrusion heads are respectively fixedly connected with the steel strands.

4. The cold-cast anchor stay cable containing the fiber grating strain according to claim 2, wherein a cross section of the perforation is stepped.

5. The cold-cast anchor stay cable containing the fiber grating strain according to claim 2, wherein the extension structure comprises an extension cylinder; one end of the extension cylinder is fixedly connected with the anchor head clamping groove, and an other end of the extension cylinder is fixedly connected with the cable body, and a sealant is poured into the extension cylinder.

6. The cold-cast anchor stay cable containing the fiber grating strain according to claim 5, wherein one end of the spot welding high-temperature grating sensor is electrically connected with an optical fiber, and an end of the optical fiber away from the spot welding high-temperature grating sensor extends out of the extension cylinder.

7. An installation method of the cold-cast anchor stay cable containing the fiber grating strain according to claim 1, comprising:
S1, applying friction to a welding point surface of the one of the steel strands and cleaning the welding point surface;
S2, welding the spot welding high-temperature grating sensor;
S3, connecting the optical fiber with an external cable force testing device;
S4, painting for protection on the spot welding high-temperature grating sensor;
S5, pouring the sealant from the cable band to the extension cylinder;
S6, pouring the epoxy mortar into the anchor head and putting the epoxy mortar into a hot furnace for heating, heat preservation and curing after the sealant is cooled and solidified; and
S7, testing an installation result and accuracy of the spot welding high-temperature grating sensor.

8. The installation method of the cold-cast anchor stay cable containing the fiber grating strain according to claim 7, comprising: in the step S6, a temperature of the hot furnace is controlled at 180 degrees Celsius, and a duration of the heating and the preservation is controlled at 24 hours.
